(19) United States
(12) Patent Application Publication
(10) Pub. No.: US 2007/0057411 A1
(43) Pub. Date: Mar. 15, 2007

(54) Method of and apparatus for treating particulate materials for improving the surface characteristics thereof

(76) Inventors: R. Lee Williams, Des Peres, MO (US); Thomas Gregory Woods, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/518,691

(22) Filed: Sep. 11, 2006

Related U.S. Application Data
(60) Provisional application No. 60/716,400, filed on Sep. 13, 2005.
(60) Provisional application No. 60/814,441, filed on Jun. 16, 2006.

(51) Int. Cl. H05H 1/26; H01J 7/24

(52) U.S. Cl. 264/483; 315/111.21

(57) ABSTRACT

Apparatus and a method is disclosed for treating particulate materials (e.g., plastic resins) so as change the surface characteristics of the particulate materials comprising a work chamber receiving a quantity of the particulate material to be treated, a power supply, and a capacitor energized by the power supply, where the capacitor generates a capacitive plasma which is used to treat the particulate material such that when objects are formed from the treated particulate material, such objects will have enhanced surface characteristics. Further, a quantity of a gas may be introduced within the work chamber to facilitate the generation of a plasma within the particulate material.

### CROSS-REFERENCE TO RELATED APPLICATIONS

This application claims the benefit of co-pending U. S. Provisional Patent Application No. 60/716,400, filed Sep. 13, 2005, and co-pending U. S. Provisional Patent Application No. 60/814,441, filed Jun. 16, 2006, both which are herein incorporated by reference.

### STATEMENT REGARDING FEDERALLY SPONSORED RESEARCH OR DEVELOPMENT

Not Applicable.

### BACKGROUND OF THE DISCLOSURE

This disclosure relates to the surface treatment of particulate materials, and more particularly to treating the surface of particulate plastic resins or other particulate materials as hereinafter described so as to improve their surface characteristics prior to post-treatment processes, such as molding objects from such treated resins, so that a wide variety of coatings, adhesives, paints, inks and other materials will better adhere to objects made of such treated particulate resins, and/or to improve the surface characteristics of such objects for enhanced surface wetability, lubricity, and surface energy or surface tension. Even more specifically, this disclosure relates to the treatment of particulate plastic resins so as to enhance the above-noted surface characteristics of objects molded from these resins. While a wide variety of particulate materials may be treated by the apparatus and method of the present invention, the process(es) of this disclosure are particularly well suited to treating the surface of powdered, granular, pelletized or other forms of particles synthetic or natural plastic resins (i.e., any solid or semi-solid fusible substance polymeric material generally recognized as a plastic, an elastomer, or a rubber-like material). In addition to such polymeric resins, particulate materials treated in accordance with the surface treatment systems and methods herein disclosed could include other materials, such as wood particles, cellulose, paint pigments (e.g., titanium dioxide, TiO₂) or the like. Moreover, it will be understood that such plastic particulate materials may be a mixture of different plastic resins and additives, such as a re-grind or recycled plastics of different resins. Such other particulate materials also could be a mixture of plastic particles and other substances such as fillers, fibers, metals, colorants such as titanium dioxide (TiO₂), elastomers, rubber, or the like.

Oftentimes, after a plastic object has been molded, adhesives, paints, inks, and other coatings will not adhere well to the surface of the plastic object. In many instances, it has been necessary to treat the surface of the molded objects so as to change the surface characteristics of the object to more readily adhere such coatings and adhesives to the objects. For example, plastic resins that typically require such surface treatment include polyethylenes of all types, polypropylene, TPO, TPE, and others. With the advent of water-based adhesives, paints, and inks, it is often desirable to surface treat objects molded of other plastic resins (e.g., styrene, ABS, PVC, engineered plastics, acrylics and polycarbonate) that, heretofore, did not require surface treatment when solvent-based adhesives, paints and inks were used.

Such post-molding surface treatment of molded plastic objects was accomplished in different of ways. For example, one such post molding treatment method involved exposing the molded object to an open flame so as to treat the surface of the object. However, such flame treatment required significant amounts of energy (e.g., natural gas), may result in warpage or shrinkage of the objects, and cannot be used with flammable plastics. Another post molding treatment process is a corona discharge treatment process in which the molded object is exposed to a corona discharge. However, the desired surface treatment is only effective on the surface where the properly adjusted corona discharge comes in contact with the part. Further, the high temperatures of such corona discharge treatment systems can melt, distort, or even burn the object. Still further, such after molded treatment systems included vacuum plasma processing in which the objects are placed in a sealed vacuum chamber which is evacuated to a low pressure, and a selected gas is introduced. The chamber is then energized by an electrical or magnetic so as to create gas plasma.

Reference may be made to the co-assigned U.S. Pat. No. 5,290,489 that discloses surface treating the interior of hollow plastic objects by creating a vacuum within the hollow object, introducing a conducting gas (e.g., argon or an argon/oxygen mixture) into the hollow object, and passing the object between a pair of electrodes so as to ionize the gas within the hollow object so as to treat the inside surfaces of the hollow object.

Lectro Engineering Company of St. Louis, Missouri has developed and has, for some years, commercially sold three dimensional surface treating equipment that operates on a capacitive electrode principle which creates a directional plasma within an atmospheric tunnel or chamber. Capacitive electrodes are positioned on opposite sides of the tunnel and a high voltage electrical field is generated so that a directional plasma discharge is effected between the electrodes. Molded parts are placed on a conveyor belt (or other means of transport) and are conveyed through the treating tunnel and are exposed to the plasma so as to surface treat the outside surfaces of the parts or objects with little or no heat generated on the object. As long as the parts will fit within the treating tunnel, the entire outer surfaces of the parts will be substantially treated. Further, Lectro Engineering Company of St. Louis, Mo. offers commercial surface treatment equipment in which a gas or gas mixture (e.g., air, CO₂, argon, nitrous oxide, or a mixture of gases) is introduced into the tunnel or into a closed chamber so as to facilitate the creation of the plasma. It will be understood that when the term “gas” is used in this disclosure that it may be a single gas, such as argon, but it also may be a mixture of two or more gasses.

Reference may be made to U.S. Pat. Nos. 4,317,778, 5,176,924, 5,215,637, 5,290,489, 5,925,325, and 6,824,872 disclose various plasma systems and methods.

### BRIEF SUMMARY OF THE DISCLOSURE

Among the several advantages of system and method herein disclosed may be noted the provision of a system and method for treating a particulate material, and particularly plastic resins, so that the particulate material will have enhanced surface properties, even after the particulate resin is formed into an object. The treated particulate material (or objects from or molded from such treated particulate material) may exhibit enhanced surface properties, such as the adhesion of inks, paint, or adhesives to the surface of objects formed from the particulate material or to change the surface characteristics of the particulate material so that the particulate material may have better wetability so that the particles may be more readily mixed with paint or other liquid, or so as to better disperse the particulate in a powder or liquid.

The provision of such a system and method that permits a particulate material, such as a plastic resin, to be so treated continuously or in batches;

The provision of such a system and method that, for most particulate plastic resin materials, does not damage, degrade, or overheat the particulate material being treated;

The provision of such a system and method in which the treated particulate material will retain its surface treatment for an adequate shelf life so as to enable the treated particulate material to be stored for a time sufficient to permit molding of objects from the treated material in commercial production environments; and

The provision of such a system and method, which in certain embodiments, does not require a vacuum chamber evacuated to a hard vacuum;

Other advantages and features of this invention will be in part apparent and in part pointed our hereinafter. Further, those skilled in the art will recognize that the apparatus and methods described by the claims of this disclosure need not embody all of the above-noted advantages and may embody other advantages not described above.

Briefly stated, one embodiment of apparatus is herein described is used to treat particulate materials (as above described) so as change the surface characteristics (as above described) of the particulate materials. Broadly stated this apparatus comprises a work chamber (which may be a plasma tunnel open to the atmosphere or a closed vessel such as a limp bag or a rigid wall container or a tunnel) receiving the particulate material to be treated. A power supply is provided that generates a plasma thereby to treat the particulate material within the work chamber. Further, a quantity of a gas or gas mixture may optionally be introduced into the work chamber to facilitate the treatment of the particulate material.

In another embodiment of the apparatus herein described comprises a work chamber (as described above) that contains a quantity of the particulate material to be treated. A gas or gas mixture (as hereinafter described) may optionally be introduced into the work chamber to facilitate the generation of a plasma within the particulate material. A conveyor conveys the particulate material through the work chamber so as to expose the particulate material to a plasma discharge and to thus treat the particulate resin.

Still further, another embodiment of the apparatus herein described treats particulate plastic resin so as to change the surface characteristics of the particulate resin and of objects molded from the resin. This apparatus comprises a plasma treatment tunnel in which a work chamber is provided for containing a quantity of the particulate resin to be treated. A conveyor conveys the work chamber through the tunnel so as to treat the particulate resin. Optionally, a partial vacuum may be drawn within the work chamber, or the work chamber may be slightly pressurized above ambient atmospheric pressure. Also, a gas or gas mixture (e.g., air, CO₂, argon, nitrous oxide, or a mixture of gases) may optionally be introduced into the work chamber with or without the presence of a partial vacuum or with or without a positive pressure above ambient within the work chamber so as to facilitate the generation of a plasma within the particulate material.

Even further, apparatus in accordance with certain aspects of this disclosure may be used to treat particulate plastic resin so as to change the surface characteristics of objects molded from the resin. Specifically, the apparatus comprises a work chamber (e.g., a tunnel) in which a plasma is generated. A quantity of the particulate plastic resin is placed within the tunnel. One or more doors may optionally close the tunnel to the atmosphere. A gas or gas mixture (such as above-described) may optionally be introduced into the tunnel where the particulate plastic resin is treated by the plasma so as to enhance the surface characteristics of the particulate plastic resin and objects molded from the treated resin. Further, a partial vacuum or a positive pressure may optionally be drawn or formed within the closed tunnel, preferably prior to the introduction of the gas or gas mixture.

Alternately, apparatus in accordance with certain aspects of this disclosure may comprise a plasma tunnel having a tube (a work chamber) extending therethrough. A conveyor (e.g., an auger conveyor) conveys a quantity of the particulate material to be treated through the tube and exposes the particulate material to capacitive directional plasma within the tube so as to surface treat the particulate material. A gas or gas mixture may be optionally introduced into the tube so as to facilitate the formation of a directional plasma discharge within the particulate material as the latter is conveyed through the tube.

Still further, this disclosure describes a method of treating particulate material (e.g., particulate plastic resins) so as to improve the surface characteristics of objects made from the particulate material. This method comprises the steps of placing a quantity of the particulate material to be treated in a work chamber, which may be a plasma treatment tunnel or a closed vessel. The work chamber is exposed to a plasma within the tunnel so as to treat the particulate material within the work chamber. The method may optionally include the steps of drawing a partial vacuum (or a positive pressure) within the work chamber, and introducing a gas or gas mixture into the work chamber so as to facilitate the generation of a plasma within the particulate material.

Even further, this disclosure includes a method of forming plastic objects from particulate resin materials that have been treated, as described in one of the above-described apparatus or methods, prior to molding the object from such treated particulate resins where the molded object has improved surface characteristics.

### BRIEF DESCRIPTION OF THE SEVERAL VIEWS OF THE DRAWINGS

FIG. 1 is a diagrammatic view of a plasma tunnel (which in this embodiment constitutes a work chamber) in which a quantity of particulate resin may be surface treated, the tunnel having a pair of spaced capacitor elements energized by a transformer for generating a directional plasma discharge within the tunnel;

FIG. 2 is a diagrammatic view of a plasma tunnel similar to that illustrated in FIG. 1 in which the capacitor is energized by a pair of transformers;

FIG. 3 is a diagrammatic view of a plasma tunnel in which the ends of the tunnel are closed by doors or the like and a gas or gas mixture is optionally introduced into the tunnel so that a quantity of particulate material may be surface treated within the tunnel, and where the tunnel may be optionally partially evacuated (or may be positively pressurized above ambient) preferably prior to the introduction of the gas or gas mixture;

FIG. 4 is a diagrammatic view of a tunnel similar to that shown in FIG. 3 in which a closed work chamber is within the tunnel where an optional mechanical stirrer (as shown in FIG. 7) is provided within the chamber for stirring a quantity of particulate material thereby to uniformly treat such particulate material, and in which a quantity of a gas or gas mixture may be introduced;

FIG. 5 is a diagrammatic view of a tunnel having a conveyor extending therethrough for conveying a quantity of particulate material through the tunnel for being surface treated, where a manifold is provided within the tunnel for introducing a gas or gas mixture;

FIG. 6 is a side elevational view of a closed, limp bag or work chamber adapted for holding a quantity of particulate material to be treated and for optionally having a partial vacuum drawn therein or having a positive pressure introduced therein and a gas or gas mixture injected therein to as to facilitate the generation of the plasma discharged within the bag;

FIG. 7 is a side elevational view of the closed, rigid wall work chamber, as may be positioned within a plasma tunnel (as illustrated in FIG. 4), containing a quantity of particulate material to be treated illustrating the provision of a mechanical paddle stirrer for mixing the particulate material being treated so as to insure a more uniform treatment of the particulate material, where a partial vacuum or a positive pressure may optionally be drawn within the work chamber and where a gas or gas mixture may be introduced into the work chamber;

FIG. 8 is a diagrammatic view of still another embodiment of apparatus for treating particulate resin having an elongate tube of a suitable dielectric material constituting a work chamber extending through a plasma treatment tunnel, the latter generating a plasma within the tunnel and within the tube, where the tube has a rotary auger disposed therein with the inlet end of the tube receiving a supply of particulate resin and with an optional gas infusion module in communication with the tube so as to optionally infuse a gas or gas mixture into the tube and into the particulate material within the tube, and where the rotary auger conveys the particulate resin through the treatment tunnel so as to expose the particulate material to the plasma discharge as the particulate material is conveyed through the tube such that treated particulate material is discharged from the tube;

FIG. 8A is a view of an alternate gas infusion module used in place of the gas infusion module shown in FIG. 8;

FIG. 9 is a diagrammatic view of still another embodiment of apparatus for treating particulate resin material having a bulk supply of particulate resin where the resin is optionally infused with a gas or gas mixture and where the particulate resin/gas mixture is packaged in sealed containers or work chambers, such as flexible wall bags, and where the bags of the resin/gas mixture are conveyed through a plasma treatment tunnel to as to surface treat the particulate resin within the bags;

FIG. 10 is a diagrammatic view of another embodiment of the apparatus herein disclosed in which a batch of particulate resin to be treated is loaded into a vertical plasma treatment tunnel, where the tunnel may be closed after it is charged with the particulate resin and where a gas or gas mixture may optionally be infused into the particulate resin within the closed tunnel either under ambient conditions, under a partial vacuum or under a slight positive pressure above ambient such that surface treatment of the particulate resin may be effected, where after treatment, the treated resin may be discharged from the tube; and

FIG. 11 is still another embodiment of the apparatus herein described that treats particulate resin in a continuous flow process where plastic resin particles are continuously discharged into a vertical plasma treatment tunnel and where a gas or gas mixture is optionally infused into the resin prior to or during treatment within the tube and where treated resin is continuously discharged from the outlet end of the tube.

Corresponding reference numerals are used throughout the several figures of the drawings.

### DETAILED DESCRIPTIONS OF PREFERRED EMBODIMENTS

The following detailed descriptions illustrate various preferred embodiments of the present disclosures by way of example and not by way of limitation. Additionally, it is to be understood that the invention(s) described in the following claims are not limited in application to the details of construction and the arrangements of components set forth in the following description of the various embodiments disclosed herein in the Summary or in the Detailed Description of Preferred Embodiments, or illustrated in the various view of the drawings.

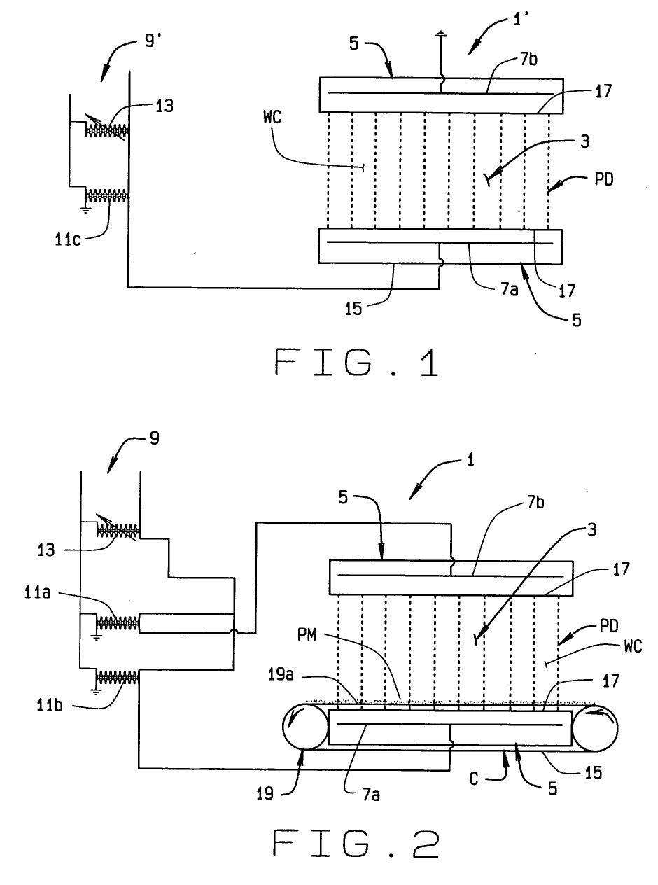

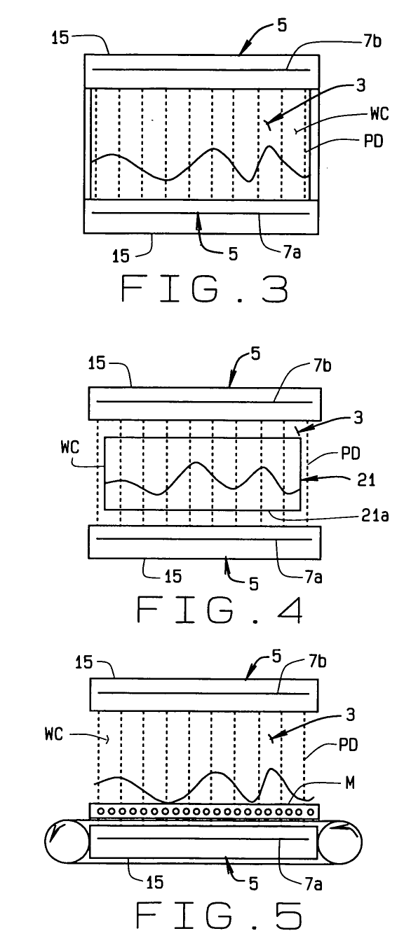

Referring now to the drawings, and more particularly to FIG. 2, a first embodiment of apparatus of this invention for surface treating a particulate material PM is indicated in its entirety at 1. The term “particulate material”, as used in this disclosure, includes, but is not limited to, powdered, granular or pelletized solid materials that are preferably, but not necessarily, flowable or pourable. Some examples of such particulate materials include plastic resins and inorganic materials such as paint pigments (e.g., titanium dioxide, TiO₂), and elastomers or other rubber-like materials. The plastic resins that can be surface treated in accordance with this invention include, but are not limed to, polyethylenes, polypropylenes, ABS, PFTE, nylons, TPO, TPE, styrene, ABS, PVC, engineered plastics, acrylics, polycarbonates, a mixture of various resins, and/or regrinds of such resins.

The term “surface treat” such particulate materials includes, but is not limited to, the improvement of such surface properties so as to increase in surface energy, frictional behavior, lubricity, cohesive strength of films, surface electrical conductivity, dielectric constant, wetability characteristics (e.g., both hydrophilic or hydrophobic), and the adhesion promotion of inks, adhesives, and paints to the surface of such particulate materials and/or to the surface of objects from such particulate materials. The term “surface treat” also encompasses the treatment of such particulate materials so as to alter the surface of such materials so as to enhance the flow, mixing, dispersion, and/or gas or particulate migration of such materials.

One aspect of this disclosure is that the method and apparatus described herein may be used to so surface treat the particulate material so that objects formed (e.g., molded) from the treated material will have such improved surface characteristics. However, the treatment system and treatment method herein described may be used to surface treat other materials that are not used to mold or otherwise form objects from the treated particulate materials.

Referring now to FIG. 2, a first embodiment of apparatus 1 of the present invention includes a plasma treatment tunnel 3, which constitutes a work chamber WC. At least a portion of the tunnel is disposed within a capacitor 5 having a pair of spaced capacitor electrodes 7a, 7b. The electrodes are energized by a power supply 9. The capacitor electrodes are energized by two high voltage transformers 11a, 11b. As shown in FIG. 1, power supply 9′ may also be a single high voltage transformer 11c connected to electrode 7a with the other electrode 7b connected to ground. When the power supply 9 of the apparatus of either FIG. 1 or FIG. 2 is energized, a directional plasma discharge PD (as indicated by the straight dotted lines between the electrodes) is generated within tunnel 3. As shown in the various drawings, the dotted lines between the electrodes denoting the directional plasma discharge are omitted in several views of the drawings for purposes of clarity. Each of the capacitor electrodes 7a, 7b is contained in housing 15. Such plasma discharge treatment tunnels are commercially available from Lectro Engineering Co., Inc., 1643 Lotsie Blvd., St. Louis, Mo. 63132, www.lectrotreat.com. While the capacitor electrodes 7a, 7b are shown in all of the drawing figures of this disclosure to be located above and below the horizontally disposed treatment tunnel 3, it will be understood that the electrodes can be located on opposite horizontal sides of the treatment tunnel. It will also be understood that when the term “plasma” is used in this disclosure, it preferably refers to a directional plasma.

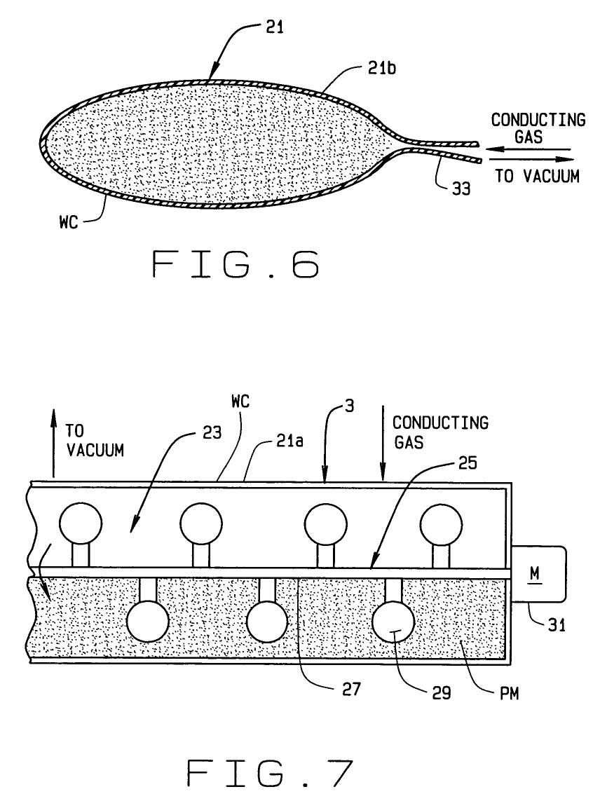

A first embodiment of the apparatus and method of the present disclosure may be carried out in the apparatus as shown in FIGS. 1 and 2. There, work chamber 3 is shown to be a tunnel disposed between capacitor electrodes 7a, 7b and is open to the atmosphere. As shown in FIG. 2, a conveyor belt 19 has an upper reach 19a that extends through tunnel 3 for conveying particulate material PM (or other objects) placed on this upper reach through the tunnel 3 to be surface treated by the plasma discharge PD formed in the tunnel. As shown in FIG. 2, the upper reach 19a of conveyor 19 may have loose particulate material PM thereon to be surface treated in accordance with this invention. Alternatively, a quantity of the particulate material PM may be placed in a closed vessel 21. As shown in FIG. 4, the closed vessel 21 may be a rigid wall chamber or container 21a, or, as shown in FIG. 6, the closed vessel 21 may be a limp, flexible wall bag 21b conveyed through the tunnel 3. A quantity of a gas or a gas mixture (as herein described above) may (optionally) be introduced into the vessel (i.e., into container 21a or into bag 21b) along with the particulate material PM to be treated prior to the vessel being conveyed through the tunnel and being exposed to the plasma discharge PM. This gas or gas mixture facilitates the generation of the plasma within the particulate material. Still further, both the limp bag 21b and/or the rigid wall container 21a may be partially evacuated (or slightly pressurized above ambient atmospheric pressure) and the gas or gas mixture may be introduced into the closed vessel prior to exposure to the plasma discharge within the tunnel. It will be understood that both the introduction of the above described gas or gas mixture and the partial vacuum (or slight positive pressure) within the container or bag (or within the tunnel) enhances the treatment of the particulate material and thus, in certain instances may be preferred, but neither the gas, the partial vacuum, or the slight pressurization are essential for operation of the apparatus or essential for carrying out the methods described herein. It should be further understood that argon is the preferred gas, but that the use of argon or any other particular gas it is not necessary, and such treatment may be carried out with only the particulate material PM exposed to atmospheric air at ambient pressure.

As used herein, those skilled in the art will understand that the term “gas or gas mixture” may include, but is not necessarily limited to, argon, carbon dioxide (CO₂), a mixture of argon and air, nitrogen, air, nitrous oxide, or other gases). Also, the terms “partially evacuated” or “partial vacuum” means only that the pressure is reduced from atmospheric barometric pressure to facilitate the introduction of the gas or gas mixture if such gas or gas mixture is used. It will be understood that the system and method of this invention will operate at atmospheric pressures or at a slight positive pressure compared to ambient atmospheric pressure, but the formation of a partial vacuum or a slight positive pressure around the particulate material PM to be treated may be preferred. As noted, after forming this partial vacuum within the vessel 21 (either rigid container 21a or in bag 21b), the conducting gas may be introduced into such vessel so that the internal pressure of the vessel at the time of treatment may be at or near (e.g., somewhat above or somewhat below) atmospheric pressure, but, of course, much of the air within the vessel will have been displaced by the conducting gas. Of course, after such vessel 21 has been conveyed through the tunnel, the particulate material may be emptied from the vessel for use as described above.

As shown in FIG. 5, a tunnel 3, as above described, is provided with a manifold M that is optionally supplied with a gas or gas mixture (as above described), which is dispensed into the tunnel as a supply of the particulate material PM is conveyed through the tunnel. It will be understood that argon is preferred so as to facilitate the formation of a plasma within the particulate material within the tunnel. However, other gases, such as described above, may be used.

Referring to FIG. 7, tunnel 3 constitutes a work chamber and an optional mechanical mixer 23 is provided in the tunnel for mixing (agitating) the particulate material PM within the tunnel and for conveying the particulate material through the tunnel so as to insure substantially uniform treatment of the particulate material. Mixer 23 is shown to be a rotary paddle mixer 25 having a horizontal shaft 27 with radially extending paddles 29. The paddles 29 may be angled with respect to shaft 27 and they are at least in part submerged in the particulate material PM so as to both agitate and convey the particulate material through the tunnel as the shaft is rotated. Shaft 27 is rotatably driven by a variable speed drive motor 31 or the like so that as the paddles move through the particulate material, the particulate material will be conveyed through tunnel 3 and stirred and mixed thus insuring that most of the material is uniformly exposed to the plasma discharge PD as the material is conveyed through tunnel 3. Other types of mixers well known in the art may be employed. For example, in place of the mechanical paddle mixer described above, the tunnel may be provided with a vibratory shaker for shaking the tunnel thereby causing the particulate material within the tunnel to be agitated within the tunnel thereby resulting in a substantial uniform mixing of the particulate material.

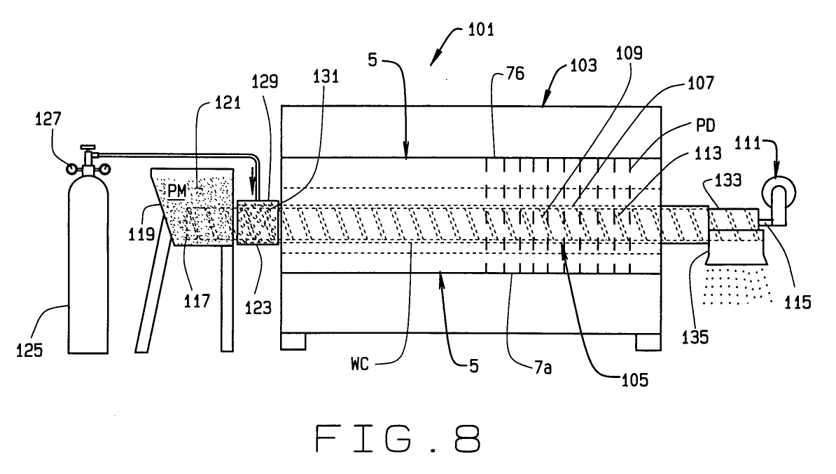

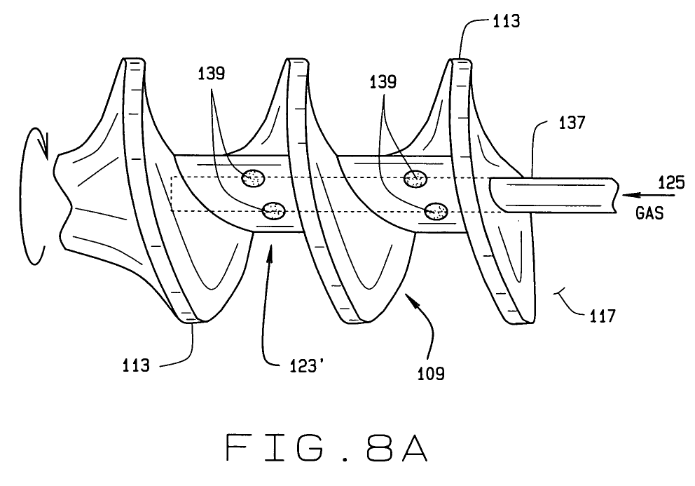

Still further, the tunnel 3 may be provided with an infuser or aerator which introduces a gas or gas mixture (as above described) into the particulate material. It has been found that an aeration stone, such as used in large aquariums, may be used to introduce the conducting gas into the particulate resin. As shown in FIG. 8A, such an aerator or infuser may be located in the center shaft of the mixer/conveyor 27, which in FIG. 8A is shown to be an auger conveyor. The gas may be withdrawn from the outlet end tunnel by a blower, and again introduced (recycled) into the vessel adjacent the inlet end of the tunnel to minimize the use of the gas or gas mixture. Even further, the bottom of the tunnel or vessel may be provided with a fluidization membrane (not shown) and a gas or gas mixture (as above described) may be introduced into a space between the bottom of the vessel and the fluidization membrane so as to fluidize the particulate material and causing a roiling action in the particulate material that will result in substantially uniform mixing of the particulate material. Such fluidized membranes are well known to those skilled in the art, as shown by U. S. Pat. 4,880,148, which is herein incorporated by reference.

Referring to FIG. 6, container or vessel 21 is shown to be a limp, flexible bag 21b. This bag may be of a suitable plastic film (e.g., polyethylene or the like) having a mouth 33 which is sealably closed after a quantity of the particulate material PM is placed therein for surface treatment. As indicated by the arrows in FIG. 6, a partial vacuum or a slight positive pressure may be formed within bag 21b via a suitable vent in the mouth of the bag thereby to remove at least some of the air from within the bag or to slightly positively pressurize the bag and a gas or gas mixture (as above described) may be injected into the bag via another vent. After the gas or gas mixture is introduced into the bag, the bag is sealed so as to entrap the gas and the particulate within the bag. However, if, after the introduction of the gas, the pressure within the bag is less than atmospheric, atmospheric pressure on the outside of the bag will compress the bag on the particulate material therein and may enhance the generation of the plasma discharge within the bag as the bag is conveyed through the plasma treatment tunnel 3.

In FIG. 8, a preferred embodiment of apparatus for carrying out the method of this disclosure is shown in its entirety at 101. It will be understood that while the embodiment of FIG. 8 is currently the most preferred embodiment, in certain instances, other(s) of the various embodiments herein described may be preferred, depending on various conditions. Specifically, the apparatus 101 provides for a continuous processing of the particulate material PM and comprises a plasma treatment tunnel 103 similar to the tunnel 3 heretofore described in regard to FIGS. 1 and 2. Apparatus 101 has a work chamber WC within tunnel 103 in the form of an auger conveyor 105 extending through the tunnel. Auger conveyor 105 includes an auger tube 107, preferably of a suitable dielectric insulation material such as tempered glass, ceramic or the like. The auger conveyor has a rotary driven auger 109 disposed within the auger tube. The auger conveyor is rotary driven by a variable speed reducer motor 111 and has a series of spaced helical flights 113 that have a sufficiently close fit within the auger tube so as to convey the particulate resin material from one end of the auger tube to the other. The auger flighting is shown to be secured to a center auger shaft 115. However, it will be understood that other types of conveyors, such as chain conveyor and “centerless” auger conveyors may be used. Preferably, the rotational speed of motor 111 may be varied so as to vary the speed of rotation of the auger and so as to increase or decrease the amount of particulate resin conveyed through the auger conveyor in a unit of time, and/or to vary the time that the particulate resin remains in the tunnel to effect treatment. As described, the auger conveyor 105 constitutes a work chamber in which the particulate material PM is treated by the plasma generated by the capacitor electrodes 7a, 7b.

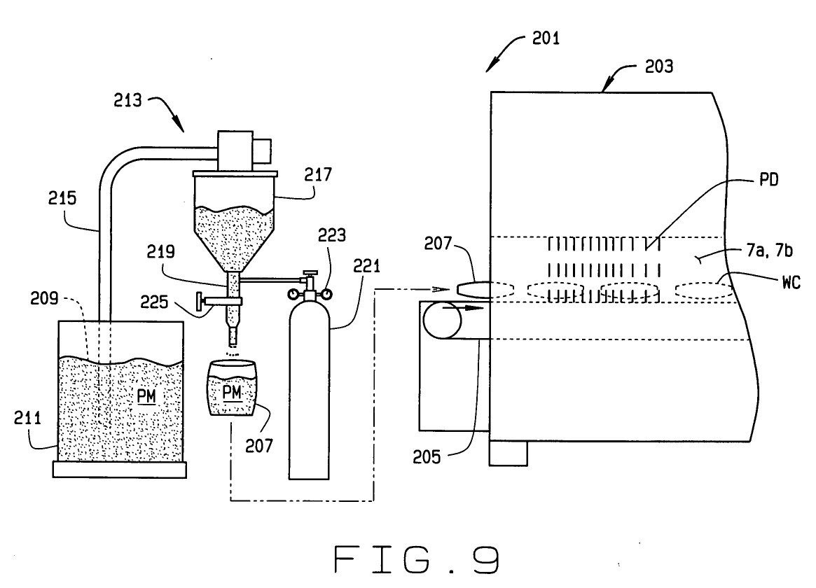

As indicated at 117, the auger conveyor 105 has an inlet end, which is in communication with a supply of particulate material PM to be treated. More specifically, a particulate resin hopper 119 is provided having a supply of particulate resin material 121 therein. As will be understood by those skilled in the art, particulate resin may be supplied to hopper 119 in any of a number of different manners, none of which is critical to the operation of apparatus 101. For example, a pneumatic conveying system, such as hereinafter described in regard to FIG. 9, may be used, or the resin may be manually dumped into the hopper from bags of the like. The particulate resin is flowable and it will enter the inlet end 117 of the auger conveyor 105 so that the rotating auger flights 113 will convey the particulate material through the length of the auger conveyor and hence through the plasma tunnel within apparatus 101 so as to be exposed to the plasma generated within the apparatus to treat the particulate material.

A conducting gas infusion module, as generally indicated at 123, surrounds a portion of auger tube 107. The infusion module is supplied with the conducting gas (as above described) under pressure from a supply 125 of such conducting gas. Alternately, gas may be infused into the particulate material using an aerator or an infusion stone, as above described. Typically, the flow rate of the gas or gas mixture (preferably argon or an argon/air mixture) is regulated to a desired operating flow rate from about 0 to about 100 standard cubic feet/hour (CFH) or more, depending on the application and the amount of particulate material to be treated in a given period of time. Generally, the flow rate of the gas is regulated so that a uniform plasma is generated within tube 107 and within the particulate material between the flights 113 of the auger 109. As heretofore described, the use of such a gas or gas mixture may be preferred, it is not necessary in the practice of the system and method of this disclosure. As heretofore described, gases such as air, CO₂, argon, nitrous oxide, or a mixture of such gases may be used, but (as noted above), argon is preferred.

As shown in FIG. 8, the infusion module 123 has a collar 129 that surrounds a portion of the auger tube 107 with the ends of the collar being sealed with respect to the exterior of the tube. One or more holes 131 are provided through the auger tube 107 within the region of collar 129 so that the conducting gas may be infused through the auger tube and into the particulate material being conveyed through the auger tube. It will be appreciated that the flighting 113 has a sufficiently close fit within the inner diameter of auger tube 107 so as to effectively prevent excess leakage of conducting gas from the ends of the auger conveyor 105 as the particulate material is conveyed through the auger conveyor. As indicated at 133, the outlet end of auger conveyor 105 extends out beyond the end of auger tube 107 and is in communication with a discharge hopper 135 disposed below the outer end of the auger so as to discharge the treated particulate material and to direct it downwardly to be received in a suitable container or bag (not shown) for shipping or storage. It will also be understood that in a continuous process, the treated material may be conveyed directly from the outlet end 133 of the auger conveyor to a storage tank or to the infeed of a molding machine so that objects may be molded from the treated particulate resin.

In FIG. 8A, another and more preferred embodiment of the infusion module is indicated in its entirety at 123′. In this embodiment, the gas supply 125 is connected to a tube 137 in the inlet end of auger shaft 115 where the tube 137 extends axially inwardly a short distance beyond the particulate hopper 119. This tube is in communication with one or more aeration outlets 139 disposed in the center shaft to extend outwardly through portions of the auger conveyor between flights 113. These aeration outlets 139 are porous so as to discharge the gas into the particulate material PM between the auger flights. Because the auger flights 113 have a relatively close fit within the auger tube 107 (not shown in FIG. 8A) and because the gas is infused at a relatively a low pressure differential with respect to atmospheric pressure, the gas will effectively be entrapped between the spaced flights 113 of the auger conveyor. Also, as the auger is rotated and as the gas is continuously discharged from aeration outlets 139 into the particulate material, good mixing of the gas and the particulate material is achieved, which facilitates the generation of a uniform plasma within the auger tube and within the particulate material PM as the particulate material is conveyed from the inlet to the outlet end of the auger tube.

In FIG. 9, another embodiment, as indicated in its entirety at 201, of the improved treatment apparatus is disclosed in which work vessels or work chambers, which may be limp bags as previously described in regard to FIG. 6, or which may be rigid wall containers or vessels, to treat the particulate resin is shown. This apparatus 201 comprises a plasma treatment tunnel 203 similar to tunnel 103 described above having spaced capacitor electrodes 7a, 7b on opposite sides of the tunnel, which are energized by one or more suitable power supplies, as above described. Apparatus 201 has an endless conveyor 205 having an upper reach that extends through tunnel 203. When work chambers 207 (either limp bags or rigid wall containers) of the resin to be treated are placed on the upper reach of conveyor 205, the work chambers 207 are conveyed through the tunnel and are exposed to the plasma generated by the electrodes in the manner heretofore described. It will be realized by those skilled in the art that other conveys may be used in place of the above-described belt conveyor. For example, a roller conveyor could be used to transport the work chambers through the tunnel.

Apparatus 201 includes a supply of particulate resin, as indicated at 209, contained within a supply container 211. A vacuum resin conveyor system, as generally indicated at 213, includes a suction tube 215 that is in communication with the resin supply 209 within container 211. The resin from container 211 is vacuum conveyed and deposited in a hopper loader 217, which feeds the resin downwardly through an outlet. A gas infuser 219 is optionally provided so as to mix a quantity of a gas or gas mixture (as heretofore described) with the particulate resin as it is discharged from the hopper loader. Again, argon is the preferred gas, but is will be recognized that other gases or gas mixtures may be used, or no gas may be used. As shown, the infuser 219 mixes a supply of the gas from a conducting gas supply 221 with the particulate material fed from hopper loader 217. A flow regulator 223 is used to insure that a desired quantity of the gas is mixed with the particulate material as the latter is discharged from the hopper loader 217 into chambers (bags) 207. Prior to the introduction of the gas into chambers 207, it will be appreciated that a partial vacuum may be drawn within the chamber so as to displace air from within the chamber. A slide gate valve 225 may be operated to start or stop the flow of the particulate material from hopper 217 to bags 207.

As shown in FIG. 9, the particulate material and the infused gas (if such a gas is used) are dispensed into a bag 207 and the bag is sealed. The sealed work chambers containing the particulate material and the gas may be stored for some time and shipped to a remote location to be treated in tunnel 203 or the bags may be directly taken to the treatment tunnel for treatment. It has been found that the sealed work chambers or bags may be stored for an appreciable period before treatment. This allows the bags filled with the particulate material and the gas (if used) to be shipped to the location of the treatment tunnel and there may be treated. It has been further found that if the treated particulate resin remains in the sealed bags or work chambers after treatment, the treated particulate resin will maintain its treatment for up to about 180 days or more after treatment.

When it is desired to treat the particulate material in bags (work chambers) 207, the bags are loaded on the upper reach of conveyor 205 and conveyed through a directional plasma treatment tunnel 203 so as to be exposed to the plasma discharge within the tunnel and thereby to surface treat the particulate material within the chambers or bags 207. The speed at which conveyor is operated and the length of the treatment tunnel along with the strength of the plasma within the tunnel will determine the degree to which the particulate material within the bags is treated. Of course, the speed of conveyor 205 may be selectively varied within in a limited range.

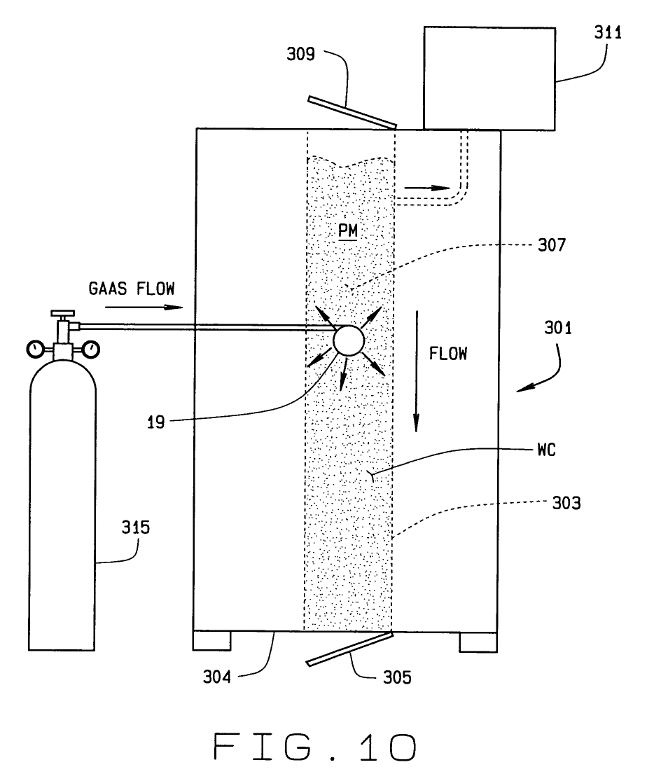

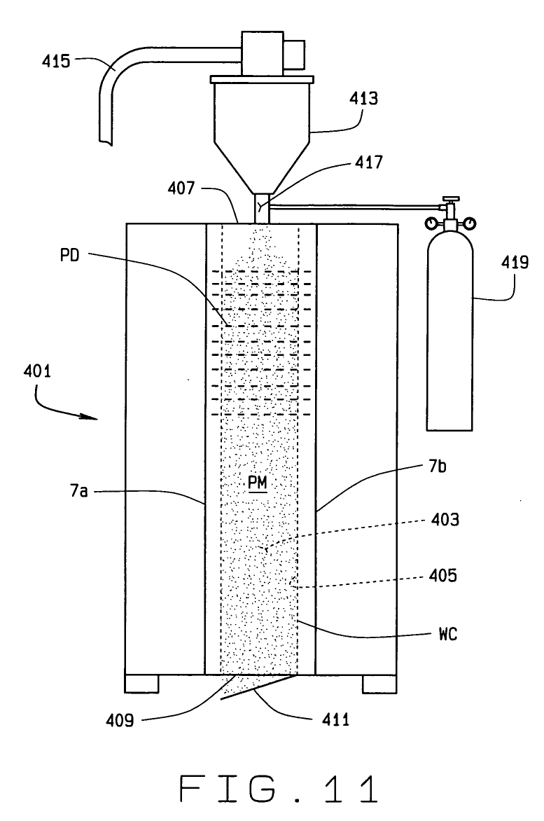

Referring now to FIG. 10, a batch treatment system for treating particulate material is indicated in its entirety at 301. This system uses a vertically disposed treatment tunnel 303 or work chamber WC, which constitutes a gravity conveyor for conveying the particulate material through the work chamber, having electrodes 7a, 7b (not shown in FIG. 10) on opposite sides of the tunnel where the electrodes are energized by a suitable power supply, as heretofore described. Tunnel 303 has an aperture opening 304 and a door 305 at its lower or outlet end and thus the tunnel constitutes a work chamber within which the particulate material PM may be treated so as to improve its surface characteristics. With door 305 closed, the tunnel 303 is filled with a particulate material to be treated and an upper or inlet end door 309 is closed. As shown, the tunnel 303 may optionally be connected to a vacuum source 311 such that with doors 305 and 309 closed, a partial vacuum may be drawn within tunnel 303. A gas or gas mixture may be optionally introduced into the tunnel after the above-noted partial vacuum is drawn using a gas infuser or aerator 313 may be used to infuse the particulate material with a charge of gas or a gas mixture so as to facilitate the generation of the plasma within the particulate material within the tunnel. That is, aerator 313 is deposed within the tunnel is connected to a supply 315 of the gas to be infused and a predetermined volume of gas may be introduced into the closed tunnel, preferably after such partial vacuum has been drawn within the tunnel. Prior to treatment, the pressure within the tunnel or work chamber may be slightly below, at, or above atmospheric pressure. After the particulate resin material 307 within tunnel 303 has been exposed to the plasma for a sufficient time as to effect treatment, the lower door 305 is opened and the treated particulate material will be discharged by gravity from tunnel 303 via aperture 304 into a suitable container or hopper (not shown). The length of time that the material 307 is exposed to the plasma discharge is dependent on a number of factors, such as the material being treated, the dimensions of the tunnel, whether a gas or gas mixture is used, and the strength of the directional plasma used to treat the material.

Referring now to FIG. 11, another embodiment of the apparatus of this disclosure is illustrated in its entirety at 401. This embodiment continuously treats the particulate resin material 403. Again, in this embodiment a treatment tunnel 405 is oriented so that the tunnel is disposed in a vertical position with capacitor electrodes 7a, 7b on opposite sides of the tunnel. The tunnel 405 has an upper or inlet end 407 and a lower or outlet end 409, and thus forms a work chamber within tunnel 405 within which the particulate resin material may be treated. As indicated at 411, a door is provided at the outlet end 409 so as to regulate the flow of the particulate material 403 through tunnel 405. Thus, door 411 acts like a valve to regulate the flow of the particulate material through tunnel 405 and the tunnel serves as a gravity conveyor for conveying the particulate material through the tunnel or work chamber WC. A hopper loader 413 is supplied with particulate plastic resin to be treated from a supply (not shown in FIG. 11) by a vacuum conveyor 415 similar to the vacuum conveying system heretofore described in regard to FIG. 9. It will be understood that a gravity feed may be used in place of vacuum conveyor 415. Further, a gas infuser 417 (similar to infuser 219 shown in FIG. 9) is supplied with a suitable gas from a gas or gas mixture supply 419 so that a suitable gas (as heretofore described) may optionally be infused with the particulate material as the latter is dispensed into the upper end of tunnel 405.

In use, the system shown in FIG. 11 dispenses a steady flow of particulate resin to be treated from hopper loader 413. As the particulate resin passes through infuser 417, it may be infused with a conducting gas. The resin and the conducting gas fall downwardly through an opening in the closed inlet end 407 of tunnel 405. As shown by the spaced dots in tunnel 405, the rate at which the treated particulate resin is discharged from outlet end 409 is regulated by door 411 so that a supply of the particulate resin may be accumulated within tunnel 405. The resin is exposed to the plasma discharge from the capacitor electrodes for a time sufficient to treat the particulate resin. The treated particulate material is continuously discharged into a suitable container.

### EXAMPLE 1

A sample of high density polyethylene (HDPE) powder was loaded into a limp plastic bag and a mixture of argon gas and air was introduced into the bag and then the bag was sealed. The bag with the resin therein was conveyed through a plasma treatment tunnel at a conveying rate of about 2 feet/minute and exposed to a directional plasma discharge for approximately 2 minutes. The surface level (also referred to as the surface energy) of the resin prior to treatment as determined to be approximately 36 dynes. Note, that while a “dyne” is generally understood to mean a unit of force that, acting on a mass of one gram, increases its velocity by one centimeter per second every second along the direction that it acts, the term “dyne” as used herein is an arbitrary unit of measurement for comparing the surface energy of the particulate material and only represents a relative comparison of the change of the surface energy of the particulate material after undergoing treatment. After treatment, the surface energy of the sample had been increased to approximate 48-50 dynes. Several days after treatment, an object was molded from the treated particulate resin in a rotational molding process where the object molded had hollow interior voids where foam insulation material was applied. It was found that the excellent foam insulation adhesion was achieved. It is noted that higher surface energy levels typically indicate a better adhesion of paints, inks, adhesives and the like. The surface tension (energy) level of these samples was determined utilizing a test kit commercially available from Lectro Engineering Company of St. Louis, Mo. The surface tension level of a sample of the particulate material was tested by compressing a sample of the particulate material to a known density and then applying different surface or wetting tension solutions to the upper surface of the sample to determine which solution would wet the particles and be adsorbed into the sample, where each of the solutions has a predetermined dyne level.

### EXAMPLE 2

At approximately one month intervals, samples of particulate resin treated in accordance with Example 1, above, the surface energy of the samples was tested on a monthly basis for approximately 6 months. As noted, the surface energy of the particulate resin had been increased from about 36 dynes to about 48-50 dynes immediately after treatment. Over the course of this six month testing period, the surface energy remained in the 48-50 dyne level.

As various changes could be made in the above constructions without departing from the scope of the invention, it is intended that all matter contained in the above description or shown in the accompanying drawings shall be interpreted as illustrative and not in a limiting sense.

1. Apparatus for treating particulate material so as change the surface characteristics of said particulate material, said apparatus comprising:
a work chamber receiving said particulate material to be treated;
a power supply; and
a pair of spaced capacitor electrodes energized by said power supply, said electrodes generating a plasma to treat said particulate material within said work chamber when positioned between said electrodes.

2. Apparatus as set forth in claim 1 wherein said work chamber is a closed container and has said particulate material and a gas therein, said gas facilitating generation of said plasma within said particulate material with said gas being selected from the group comprising air, nitrogen, argon, carbon dioxide, nitrous oxide, or a mixture of such gases.

3. Apparatus as set forth in claim 2 wherein said closed work chamber is a limp bag.

4. Apparatus as set forth in claim 2 wherein said closed work chamber has substantially rigid walls.

5. Apparatus as set forth in claim 1 wherein said particulate material is exposed to a gas for facilitating the formation of said plasma within said particulate material.

6. Apparatus as set forth in claim 5 wherein said gas is selected from the group comprising air, nitrogen, argon, carbon dioxide, nitrous oxide, or a mixture of such gases.

7. Apparatus as set forth in claim 2 wherein, prior to introducing said gas into said container, a partial vacuum is drawn within said container.

8. Apparatus as set forth in claim 2 wherein, prior to introducing said gas into said container, said container is positively pressurized above ambient atmospheric pressure.

9. Apparatus as set forth in claim 2 wherein said container is conveyed between said electrodes so as to expose the particulate material within said container to said plasma and to thus surface treat said particulate material within said container.

10. Apparatus as set forth in claim 1 wherein said work chamber is a tunnel with said electrodes disposed relative to said tunnel so as to generate a plasma within said tunnel, said apparatus further comprising a conveyor extending through said tunnel for conveying said particulate material therethrough.

11. Apparatus as set forth in claim 10 wherein said work chamber is a tube disposed within said tunnel, and wherein a conveyor is disposed within said tube for conveying said particulate material through said tube for treatment of said particulate material by said plasma generated within said tunnel by said electrodes.

12. Apparatus as set forth in claim 11 wherein said conveyor is an auger conveyor.

13. Apparatus as set forth in claim 12 wherein a gas is introduced into said tube so as to aid in the treatment of said particulate material by said plasma.

14. Apparatus as set forth in claim 13 wherein said gas is selected from the group comprising air, nitrogen, argon, carbon dioxide, nitrous oxide, or a mixture of such gases.

15. Apparatus as set forth in claim 12 wherein said auger conveyor a rotary auger conveyor and has at least one helical flight so that as said auger conveyor is rotated, said auger conveys said particulate material through said tube.

16. Apparatus as set forth in claim 12 wherein said tube has an inlet end and an outlet end, said inlet end being supplied with particulate material to be treated and treated material being discharged from said outlet end.

17. Apparatus as set forth in claim 11, wherein said tube is of a suitable dielectric material.

18. Apparatus as set forth in claim 13 wherein said tube has a gas infuser for introducing said gas into said particulate material.

19. Apparatus as set forth in claim 16 wherein said gas infuser comprises a collar at least in part surrounding said tube, one or more openings in said tube in the area of said collar, said collar being sealed with respect to the outer surface of said tube and being in communication with a supply of said gas whereby gas from said supply is introduced into said particulate material within said tube through said one or more holes in said tube.

20. Apparatus as set forth in claim 18 wherein said gas infuser comprises a gas conducting conduit extending into the inlet end of said auger conveyor, said gas conducting tube being in communication with a supply of said gas, said gas conducting tube being in communication with an aerator for introducing said gas into said particulate material in the inlet end portion of said tube.

21. Apparatus as set forth in claim 10 wherein said tunnel is open to the atmosphere.

22. Apparatus as set forth in claim 1 wherein said work chamber is a tunnel at least in part disposed between said electrodes, said tunnel having a quantity of said particulate material to be treated disposed therewithin and being closed to the atmosphere.

23. Apparatus as set forth in claim 22 having a gas introduced into said tunnel where said gas is selected from the group comprising air, nitrogen, argon, carbon dioxide, nitrous oxide, or a mixture of such gases.

24. Apparatus as set forth in claim 23 wherein said tunnel is provided with a mixer for said particulate material so that said particulate material is substantially uniformly treated.

25. Apparatus as set forth in claim 24 wherein said mixer is a mechanical mixer disposed within said tunnel.

26. Apparatus as set forth in claim 25 wherein said mechanical mixer is a paddle mixer.

27. Apparatus as set forth in claim 24 wherein said mechanical mixer is an auger conveyor.

28. Apparatus as set forth in claim 24 wherein said mixer accomplishes mixing of said particulate material by vibrating said particulate material within said tunnel.

29. Apparatus as set forth in claim 24 wherein said mixer comprises an aerator that agitates said particulate material within said tunnel as it is being treated.

30. Apparatus as set forth in claim 29 wherein said aerator utilizes said gas for agitating said particulate material.

31. Apparatus as set forth in claim 22 wherein said tunnel is closed, and wherein a partial vacuum is drawn within said tunnel after said particulate material is disposed therein prior to the introduction of said gas.

32. Apparatus as set forth in claim 1 wherein said apparatus further has a tunnel at least in part disposed between said electrodes, said tunnel having a conveyor for conveying one or more of said work chamber through said tunnel, said work chambers containing a quantity of said particulate material to be treated.

33. Apparatus as set forth in claim 32 wherein said work chamber comprises one or more closed vessels.

34. Apparatus as set forth in claim 33 wherein a partial vacuum is drawn within said closed vessels.

35. Apparatus as set forth in claim 29 wherein a gas is introduced into said vessel so as to facilitate the generation of a plasma within said particulate material.

36. Apparatus as set forth in claim 35 wherein said vessel is a limp bag.

37. Apparatus as set forth in claim 35 wherein said vessel is a rigid wall container.

38. Apparatus as set forth in claim 1 wherein said particulate material is particulate plastic resin.

39. Apparatus as set forth in claim 38 wherein said particulate plastic resin may be selected from a group comprising polyethylene, polypropylene, TPO, TPE, styrene, ABS, PVC, engineered plastics, acrylic, polycarbonate, and/or a mixture thereof.

40. Apparatus as set forth in claim 35 wherein said particulate material is infused with said gas prior to introduction of said particulate material into said vessels.

41. Apparatus as set forth in claim 40 wherein said vessels are limp bags, and wherein said bags are sealed with said conducting gas and with said particulate material therein.

42. Apparatus as set forth in claim 1 wherein said work chamber is a plasma tunnel disposed in a vertical position having said electrode arranged so as to generate a plasma within said tunnel, said tunnel having an upper inlet end and a lower outlet end, a door for sealing said lower end of said tunnel, said tunnel being adapted to receive a batch of said particulate material to be treated by said plasma.

43. Apparatus as set forth in claim 42 further having a closure for the upper or inlet end of said tunnel, said apparatus comprising a vacuum source in communication with said tunnel for forming a partial vacuum therein.

44. Apparatus as set forth in claim 43 further comprising a supply of a gas which facilitates the formation of a plasma within said particulate material, said apparatus further comprising a gas inlet for introducing said gas into said tunnel.

45. Apparatus as set forth in claim 42 wherein upon completing treatment of said batch of particulate material, said lower door may be opened to discharge said particulate material from said tube.

46. Apparatus as set forth in claim 1 wherein said work chamber is a vertical tunnel having an upper or inlet end and a lower outlet end, a supply of said particulate material continuously supplied to the upper end of said tunnel, a valve at the outlet end of said tunnel for regulating the flow of particulate material through said tunnel so that said particulate material is continuously treated by said plasma as it flows from said upper to said lower end of said tunnel.

47. Apparatus as set forth in claim 46 having a supply of a gas for introduction into said tunnel so as to facilitate the formation of a plasma within said particulate material disposed within said tunnel.

48. Apparatus for treating particulate material so as to change the surface characteristics of said particulate material and of objects made from said particulate material, said apparatus comprising:
a capacitor having a pair of spaced electrodes for generating a plasma;
a quantity of said particulate material to be treated; and
a conveyor for conveying said particulate material between said electrodes so as to treat said particulate resin.

49. Apparatus for treating particulate plastic resin so as to change the surface characteristics of objects molded from said resin, said apparatus comprising:
a capacitor having a pair of spaced electrodes;
a work chamber containing a quantity of said particulate resin to be treated;
a partial vacuum within said work chamber; and
a gas introduced into said work chamber for facilitating the generation of a plasma within said particulate resin.

50. Apparatus for treating particulate plastic resin so as to change the surface characteristics of objects molded from said resin, said apparatus comprising:
a tunnel in which a directional plasma is generated; and
a quantity of said particulate plastic within said tunnel to be exposed to said directional plasma for treating the surface of said particulate plastic resin thereby to enhance the surface characteristics of said particulate plastic resin and objects molded from said treated resin.

51. Apparatus as set forth in claim 50 wherein a partial vacuum is formed within said tunnel.

52. A method of treating a particulate material so as to improve the surface characteristics of objects made from said particulate material, said method comprising the steps of:
placing a quantity of said particulate material to be treated in a work chamber; and
exposing said work chamber to a directional plasma so as to surface treat said particulate material.

53. The method of claim 52 wherein in said a directional plasma is generated by a pair of spaced capacitor electrodes.

54. The method of claim 53 wherein said work chamber is closed to the atmosphere, and wherein said method further comprises drawing a partial vacuum within said work chamber.

55. The method of claim 53 wherein said work chamber is closed to the atmosphere, and wherein said method further comprises pressurizing said work chamber so as to positively pressurize said work chamber above ambient atmospheric pressure.

56. The method of claim 53 further comprising the step of conveying work chamber between said electrodes thereby to generate said directional plasma for treating said particulate material.

57. The method of claim 53 further comprising the step of introducing a gas into said work chamber so as to facilitate the generation of a plasma within said particulate material.

58. The method of claim 52 wherein said work chamber is a limp bag.

59. The method of claim 52 further comprising the step of conveying said particulate material through said tunnel.

60. The method of claim 59 wherein said particulate material is conveyed through said tunnel in a closed tube, and wherein a gas is introduced into said tube.

61. A method of treating particulate plastic resin so as to improve the surface characteristics of objects molded from said resin, said method comprising the steps of:
surface treating said particulate plastic resin prior to molding said objects from said treated particulate plastic resin;
wherein said treating step includes exposing said particulate plastic resin to a plasma so as to treat the surfaces of said plastic resin particles; and
molding an object from said treated particulate resin material thereby to enhance the surface characteristics of said object.

62. The method of claim 61 further comprising positioning said particulate plastic resin between a pair of spaced capacitor electrodes so as to generate said plasma.

63. The method of claim 62 further comprises infusing said particulate plastic resin to a gas for facilitating generating a plasma within said particulate plastic resin when positioned between said electrodes.
